(19) United States
(12) Patent Application Publication
(10) Pub. No.: US 2008/0117298 A1
(43) Pub. Date: May 22, 2008

(54) Covert camera apparatus for a doorframe and method

(76) Inventor: David J. Torres, Plano, TX (US)

Correspondence Address: George R. Schultz;Schultz & Associates, P.C., Suite 1200, One Lincoln Centre, 5400 LBJ Freeway, Dallas, TX, 75240, US

(21) Appl. No.: 11/801,651

(22) Filed: May 9, 2007

Related U.S. Application Data
(63) Continuation-in-part of application No. 11/602,661, filed on Nov. 21, 2006.

(51) Int. Cl. H04N 7/18

(52) U.S. Cl. 348/151

(57) ABSTRACT

The invention disclosed provides an apparatus and method for a surveillance camera having various attributes which make it advantageous in security applications. The invention allows for the quick adjustment of camera angle or the removal of the camera frame assembly, supplies a solution for video distorting caused by ground looping, and can provide a video signal to devices which record, store, or transmit images via RF to a monitor in a remote location. The apparatus includes a shock absorbing functionality and a decoy plastic faceplate including a card reader or biometrics reader. The plastic faceplate can be imprinted with a design, message, and heat and/or pressure sensitive paint. The camera frame and mounting bracket are assembled together to allow easy adjustment of the camera angle through an arc path of up to 120° without dismantling the camera frame assembly.

### CROSS-REFERENCE TO RELATED APPLICATIONS

This application is a Continuation-In-Part claiming priority benefit from U.S. patent application Ser. No. 11/602,661 entitled “Covert Camera Apparatus for a Doorframe and Method” filed on Nov. 21, 2006.

### FIELD OF THE INVENTION

This invention relates to an apparatus for covert surveillance. In particular, this invention relates to an apparatus and method for mounting a miniaturized camera in, on or near a doorframe or other structure and orienting the apparatus for conducting covert camera surveillance.

### BACKGROUND OF THE INVENTION

Currently there are many video surveillance devices in the marketplace that monitor given areas or situations. An essential function of a video surveillance system is to capture clear images of the subjects being monitored. Often the image captured is used to identify a perpetrator, and therefore the best image possible and from the most beneficial vantage point is of utmost importance. Concealed cameras generally offer the best opportunity to clearly identify perpetrators.

Prior art efforts to discreetly monitor an area include miniaturizing a camera and positioning it in ordinary fixtures such as mannequins, light fixtures, clocks, smoke detectors, or door knobs. U.S. Pat. No. 6,554,499 to Gumpenburger discloses a miniaturized camera affixed to a height measurement strip mounted to the wall or doorframe near the exit of a convenience store. One problem with this system and other prior art systems is that they lack the capability to easily adjust and fine-tune the camera angle without the inconvenience and delay of dismantling the apparatus to make the adjustment. Further, the prior art camera angle adjustments are limited.

Another problem with prior art video surveillance systems is ground looping. Ground looping occurs where there is a difference in potential voltage in the ground connection path between two pieces of equipment. In a video system, ground looping causes video hum that is usually observed as vertically moving horizontal bars slowly rolling through the video image. Video hum can also cause video distortion or even loss of the picture in severe cases.

Another problem with prior art video capture systems is the susceptibility to damage from sudden shocks. The prior art systems are easily damaged and require repair or replacement if subjected to typical impact loads. Impact loads due to tampering and vandalism are common in areas where security cameras are typically deployed. Still further, in the prior art, it has been difficult to detect tampering with a camera from mere visual inspection. Usually, to detect tampering in prior art systems, it is necessary to check camera angles from a video monitor. Such a necessity many times causes lost video capture due to the delay between damage of the camera and discovery of the damage. Not only is replacing a damaged video capture system expensive, but while the system is being repaired or replaced, the user is without a video capture system and thus unprotected.

As shown in FIGS. 1a and 1b, it is known in the prior art to mount a lens of a miniaturized camera in a grommet supported by a pair of offset flanges. The tolerance between the hole in the grommet and the lens is sufficiently large to allow the camera to be easily moved. Angle adjustments in the lens are made in the prior art by using a tie wire fed through wire holes in the flanges and around the camera body. The wire is twist tightened to the opposite side of the desired camera sight line. The taught wire holds the camera to the desired angle. This method of altering the camera angle has not been entirely satisfactory because it lacks precision in defining camera angle and is prone to movement if the camera is subject to impact. The use of the tie wire has also not been satisfactory because it electrically connects the body of the camera with the external frame thereby allowing for an electrical ground loop. Further, the wire monitoring has not been satisfactory because it is easily misaligned by a shock on impact to the housing.

While the prior art offers some rudimentary ability to position camera angle, none has addressed the ground loop potential and none has the capability to withstand an impact without damage or need for adjustment and without easy determination.

It is then a goal of the present invention to provide a covert video surveillance system that produces high quality images.

It is another goal of the present invention to provide a covert video surveillance system that is mounted to a doorframe or other structure without substantial modifications to the existing structure.

It is another goal of the present invention to provide a covert video surveillance system, which includes a miniaturized camera mounted in a hingebly and removably mounted frame assembly.

It is another goal of the present invention to provide a covert video surveillance system, which can withstand and absorb the shock from a perpetrator's attack.

It is another goal of the present invention to provide a covert video surveillance system, which includes a camera frame assembly that has the ability to easily adjust the camera angle with durable precision and without disassembling the camera frame assembly.

It is another goal of the present invention to provide a covert video surveillance system, which prevents ground loop interference.

It is a further goal to provide a covert video surveillance system that can be easily adapted to meet a large number of deployment scenarios and further to be easily reconfigurable.

It is a further goal to provide a covert video surveillance system with a mechanism to easily indicate tampering by visual inspection of the camera.

### SUMMARY OF INVENTION

The invention provides an apparatus and method for a covert video surveillance system mounted to a doorframe or any structure where video monitoring is desired. The invention is designed to allow the apparatus to be easily and adjustably mounted without substantial modification to the structure of the doorframe or other mounting surface. The camera frame assembly and mounting bracket are designed to allow simple adjustments of the camera angle without dismantling the camera frame assembly and to withstand direct impact forces intended to damage the apparatus. The camera angle can be further adjusted an additional five degrees in any direction as a result of the flexible nature of the rubber-like grommet imparting a friction gripping action on the camera. The invention also utilizes the non-conductive nature of the rubber-like grommet to insolate the camera from ground looping and protect the image from video hum. The invention also provides a mechanism to allow easy reconfiguration of the camera body for different deployment situations and further provides a mechanism for easy detection of tampering or impact.

The apparatus includes a mounting bracket formed in a U-shape with an oblong hole of constant width on each side, two mounting holes, and a pass through hole for the video and power cords of the camera and/or any other devices. The camera frame is attached to the mounting bracket via two bolts through the oblong holes. The bolts are adjustable by hand. The camera frame assembly is made up of the camera frame top, the camera frame bottom, the rubber-like grommet, a CCTV camera including a power cord and a video cable, shock absorbing dampers, and a plastic cover/faceplate. The camera frame top has a hole through its top surface flanked by two offset flanges. The flexible insulation grommet is mounted in the hole on the two flanges creating a space for mounting the camera. In one embodiment, the camera is positioned inside the flexible insulation grommet and held in place by friction. In another embodiment, threaded adjustments are provided. The camera frame bottom fits inside the camera frame top and is attached with four screws through the sides of each. In another embodiment, shock absorbing dampers are located inside the camera frame assembly and are attached to the plastic cover/faceplate and the camera frame bottom. The plastic faceplate is attached to the dampers by two flat head screws and is transparent directly over the lens of the camera. The faceplate not only serves to protect the camera lens, but also to conceal the apparatus. In an alternate embodiment, the invention utilizes a completely transparent faceplate in combination with interchangeable inserts. The inserts add to the covert nature of the device by functioning as signage or camouflage.

In yet another embodiment, a pressure sensitive paint is used in connection with the faceplate to visually display evidence of tampering or impact.

### BRIEF DESCRIPTION OF THE DRAWINGS

In the detailed description of the preferred embodiments presented below, reference is made to the accompanying drawings.

FIG. 1a is a section view showing a Prior Art video camera supported by a grommet and secured by wire mounted on flanges.

FIG. 1b is a section side view of Prior Art taken along line 1b-1b of FIG. 1a showing camera angle adjustments via wire.

FIG. 2 is a perspective view of an assembled covert camera apparatus.

FIG. 3 is an exploded view of the components of a covert camera apparatus.

FIG. 4a is a plan view of an assembled covert camera apparatus.

FIG. 4b is a section view of the camera frame assembly showing shock absorbing dampers.

FIG. 5a is an elevation view of an assembled covert camera apparatus depicting the camera's sight line perpendicular to the mounting surface.

FIG. 5b is an elevation view of an assembled covert camera apparatus depicting the camera's sight line adjusted 600 from center.

FIG. 6a is a plan view of a camera frame top.

FIG. 6b is a plan view of an alternate embodiment of a camera frame top.

FIG. 7 is a section view taken along line 7-7 of FIG. 6a depicting an alternative preferred embodiment.

FIG. 8 is a section view taken along 7-7 of FIG. 6a depicting an alternative preferred embodiment.

FIG. 9 is a perspective view of an alternate embodiment of an assembled covert camera apparatus including a magnetic card reader.

FIG. 10 is a sectional view of camera frame assembly showing closed cell plastic shock absorbing foam.

FIG. 11 is a sectional view of camera frame assembly showing shock absorbing rubber washers.

FIG. 12 is a perspective view of an alternate embodiment of an assembled covert camera apparatus including a transparent faceplate and a changeable insert.

FIG. 13a is a section view of the apparatus with a changeable insert.

FIG. 13b is a plan view of an alternate embodiment of the present invention showing a transparent faceplate and a frictionally mounted changeable insert.

FIG. 14 is a schematic view of an alternate embodiment including a lenticular lens and a various set of displayed messages.

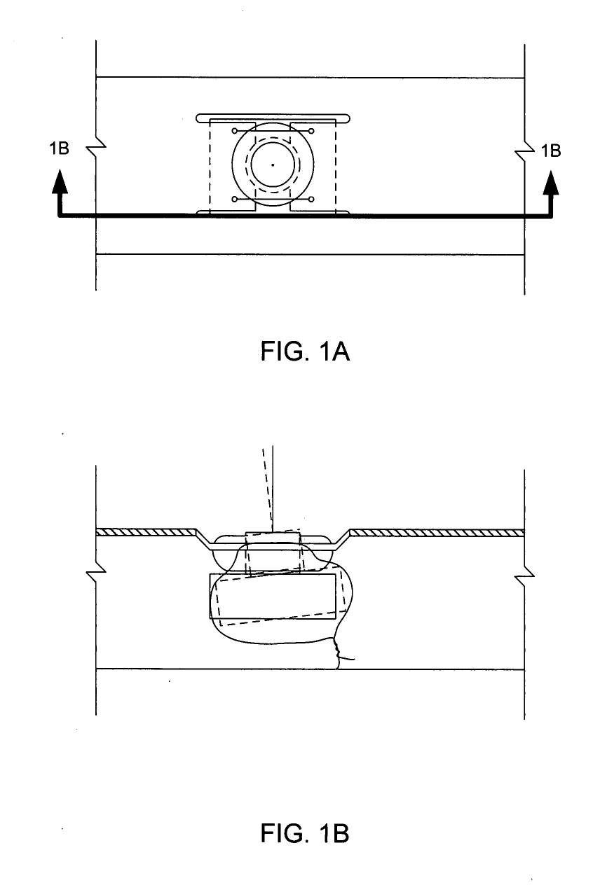

### DETAILED DESCRIPTION OF THE PREFERRED EMBODIMENT

In the descriptions that follow, like parts are marked throughout the specification and drawings with the same numerals, respectively. The drawing figures are not necessarily drawn to scale and certain figures may be shown in exaggerated or generalized form in the interest of clarity and conciseness.

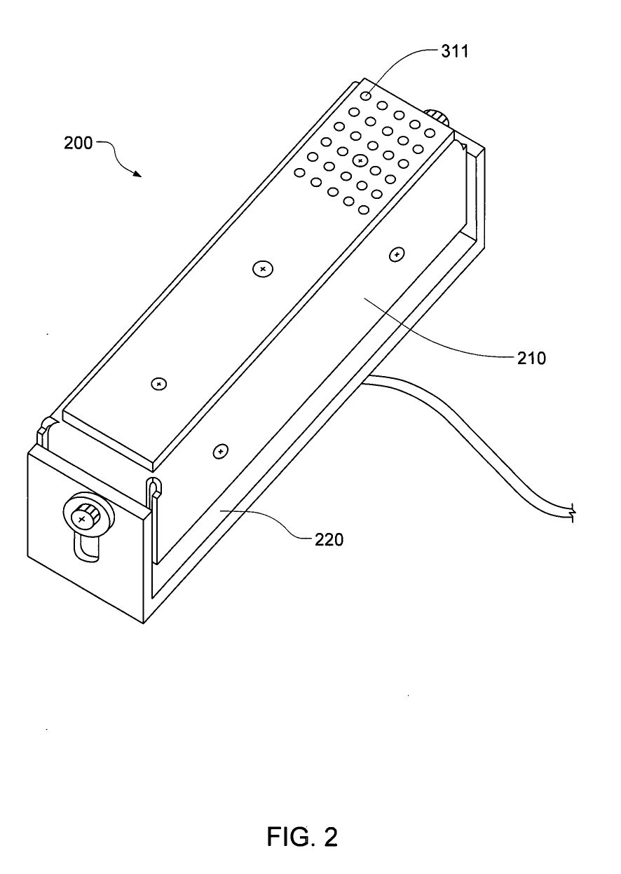

FIG. 2 shows covert camera apparatus 200 is comprised of camera frame assembly 210 and mounting bracket 220. Covert camera apparatus 200 is mounted anywhere surveillance is required. For example, the apparatus may be mounted on a door frame or a bank teller's station as a name plate holder. Covert camera apparatus 200 may also be employed in situations such as drive through pharmacies and automated teller machines. Covert camera apparatus 200 is compact and light to facilitate mounting discreetly and without substantial modifications to the mounting surface. In the preferred embodiment, mounting bracket 220 is formed in a U-shape and is made of ⅛ in. thick metal such as steel or aluminum alloys. In other embodiments, the various frames and covers could be made of rigid plastic.

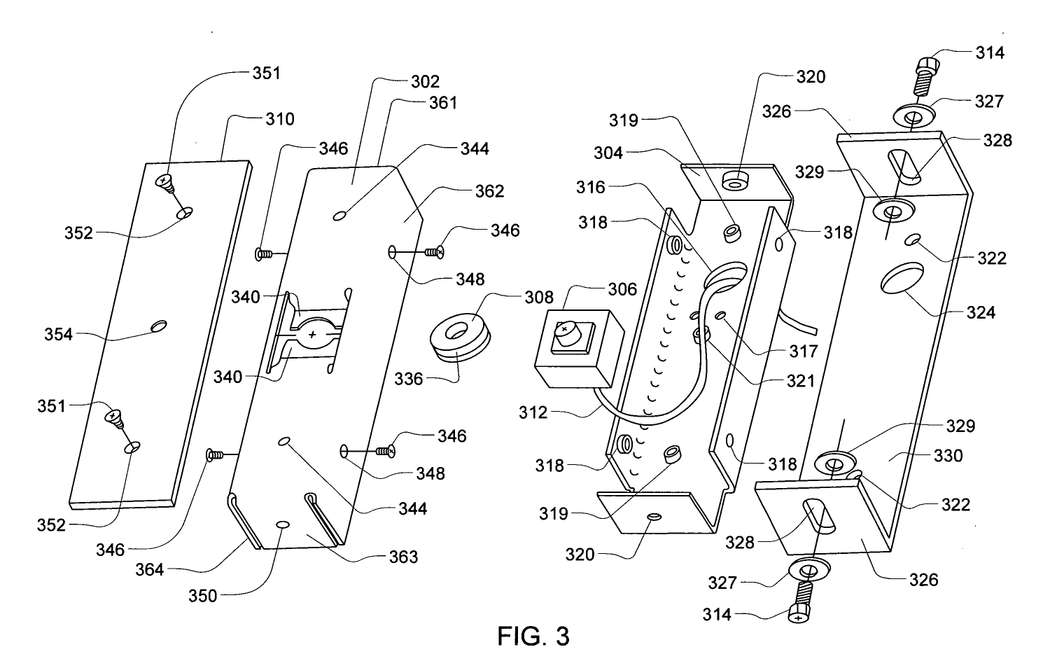

FIG. 3 shows mounting bracket 220 in greater detail. The mounting bracket is comprised of mounting bracket base 330 and two mounting bracket sides 326. In the preferred embodiment mounting bracket base 330 is approximately 6¼ inches long. Two mounting bracket sides 326 are perpendicular to mounting bracket base 330 and are approximately 1¼ inches long. Mounting bracket base 330 has two mounting holes 322 located along its lengthwise centerline and approximately 1 inch from each mounting bracket side 326. In the preferred embodiment, mounting holes 322 are ⅛ inch in diameter, but can be any size sufficient to receive mounting screws capable of securely supporting mounting bracket 220 and camera frame assembly 210. Mounting bracket base 330 also has hole 324 for power cord and video cable 312 of camera 306. Camera 306 provides a video feed for many different devices capable of displaying, recording, storing, or transmitting images via RF to a monitor in a remote location. In the preferred embodiment, hole 324 is approximately ¾ inch in diameter and is located along the lengthwise center line of mounting bracket base 330 and approximately 1¼ inch from mounting bracket side 326 but can be located anywhere on mounting bracket base 330.

Mounting bracket sides 326 each are provided with a single slotted adjustment hole 328. Each slotted adjustment hole 328 is an oblong hole of constant width located on the lengthwise centerline of each mounting bracket side 326 and in the preferred embodiment is approximately ¾ inch long and ¼ inch wide beginning approximately 3/16 inch from the open end of mounting bracket side 326. Bolt 314 and two washers 327 are used to secure camera frame assembly 210 to mounting bracket 220 through each slotted adjustment hole 328. Rubber washer 329 is made of rubber or similar flexible compressible material and is used on the inside surface of mounting bracket side 326. Bolt 314 is capable of being tightened or loosened by hand.

Camera frame assembly 210 houses camera 306 and provides gross adjustments for the sight line of camera 306. Camera frame assembly 210 can be adjusted by loosening bolts 314 and rotating camera frame assembly 210 about the center axis of bolts 314. About 120 degrees of camera rotation about the longitudinal axis of the apparatus can be achieved in the preferred embodiment. Camera frame assembly 210 can also be adjusted about its latitudinal axis by loosening bolt 314 and sliding camera frame assembly 210 within slotted adjustment hole 328. About 25 degrees of camera rotation about the latitudinal axis can be achieved.

FIG. 3 also shows camera frame top 302, camera frame bottom 304, camera 306 including power cord and video cable 312, grommet 308, and faceplate 310. Camera frame top 302 and camera frame bottom 304 are both formed generally in the shape of a five sided oblong box.

The base surface of camera frame bottom 304 has cable hole 316 and damper holders 319 and 321. Cable hole 316 is approximately ¾ inch in diameter and located such that when camera frame bottom 304 is secured adjacent to mounting bracket 220, cable hole 316 is concentrically aligned with hole 324 located on mounting bracket base 330. Damper holders 319 and 321 in the preferred embodiment comprise short threaded cylindrical standoffs rigidly secured to the inside frame of camera frame bottom 304. The damper holders are located such that when camera frame bottom 304 and camera frame top are secured together, damper holders 319 are concentrically aligned with faceplate holes 344. Damper holder 321 is concentrically aligned with camera hole 342. In the preferred embodiment, damper holders 319 and 321 are threaded to receive a damper base bolt. The base surface of camera frame bottom 304 also has two tie-down holes 317. Tie-down holes 317 are used to secure power cord and video cable 312 to the base surface of camera frame bottom 304. In the preferred embodiment, tie-down holes 317 are located approximately ½ inch from each other and within approximately ½ inch from cable hole 316. A cable tie (not shown) or other securing means is threaded through the two tie-down holes 317 and over power cord and video cable 312 securing power cord and video cable 312 to camera frame bottom 304. Perpendicular to the base surface of camera frame bottom 304 are four side surfaces forming the sides of the oblong box shape. In the preferred embodiment, the overall length of camera frame bottom 304 is approximately 5⅞ inch. The two major sides of camera frame bottom 304 are approximately 4½ inch long and are centered along the length leaving approximately ⅝ inch open space on each end between them and the minor sides. In the preferred embodiment, the overall width of camera frame bottom 304 is 1⅝ inch. The two minor sides of camera frame bottom 304 are approximately 1⅜ inch wide and are centered along the width leaving approximately ⅛ inch open space on each end between them and the major sides. Each major side has two frame bottom assembly holes 318 and both minor sides have one frame bottom bolt hole 320. Frame bottom assembly holes 318 are both approximately located on the lengthwise centerline of the major sides and ½ inch from the sides of the major sides. One frame bottom bolt hole 320 is located in the approximate middle of each minor side. Frame bottom bolt holes 320 are threaded to receive bolts 314. Frame bottom assembly holes 318 are threaded to receive assembly screws 346.

In the preferred embodiment, camera 306 is a miniaturized color charge-coupled device camera contained in a compact package having dimensions of approximately 1⅛ inch wide, 1⅛ inch long, and ¾ inch tall; part no. ______, available from Samsung, Inc. of China. The cylindrical portion of camera 306 that houses the lens is approximately ½ inch in diameter. The cylindrical portion of camera 306 fits snugly into a centered circular hole approximately ½ inch in diameter in grommet 308. In the preferred embodiment, grommet 308 is generally cylindrical with an approximate diameter of 1 inch. The grommet is approximately ¼ inch thick, and includes an annular indention 336 in the outside surface of its circumference. In the preferred embodiment, the grommet is made of natural rubber or silicon rubber. The rubber material absorbs impact loading that may be applied to covert camera apparatus 200 and electrically insolates camera 306 from possible ground loop problems. In the preferred embodiment, annular indention 336 is approximately ⅛ inch deep. In other embodiments the grommet can have outside peripheral shapes that are square or rectangular in shape. Because grommet 308 is made of a non-conductive material, grommet 308 prevents ground looping.

Grommet 308 is attached to camera frame top 302 through a fraction fit between annular indention 336 and mounting flanges 340. In order to accommodate a friction fit, the inside diameter of the hole in the grommet is approximately 1 mm smaller than the outside diameter of the camera lens. The smaller diameter of the hole in the grommet is an advance over the art because it facilitates a stable support for the camera lenses by frictional engagement. The flexibility of the friction fit allows for minor camera angle adjustments up to approximately five degrees in any direction.

In the preferred embodiment, camera frame top 302 and camera frame bottom 304 are made of a light aluminum or steel alloy of approximately 1/16 inch thick. The top surface of camera frame top 302 has faceplate holes 344 and camera hole 342 flanked by two offset mounting flanges 340. In one embodiment, camera hole 342 and mounting flanges 340 are located in the center of camera frame top 302. In another embodiment, camera hole 342 flanked by mounting flanges 340 is located off center to accommodate additional devices such as a card reader. Camera hole 342 and mounting flanges 340 are offset below the top surface of camera frame top 302 approximately ⅛ inch. Perpendicular to the top surface of camera frame top 302 are minor sides 361 and 363 and major sides 362 and 364. Together the long sides and the short sides form four sides of an oblong box shape. In the preferred embodiment, the overall length of camera frame top 302 is approximately 6 inches. In the preferred embodiment, the overall width of camera frame top 302 is 1¾ inch. The two minor sides of camera frame top 302 are approximately 1½ inch wide and are centered along the width leaving approximately ⅛ inch open space on each end between them and the major sides. Each major side has two frame top assembly holes 348 and both minor sides have one frame top bolt hole 350. One frame top bolt hole 350 is located in the approximate middle of each minor side. The overall dimensions of camera frame top 302 are slightly larger than those of camera frame bottom 304. When assembled, camera frame bottom 304 fits inside of camera frame top 302.

In the preferred embodiment, faceplate 310 is approximately 5¾ inches in length and 1½ inches wide. Faceplate 310 is made of a transparent, shock resistant plastic and is approximately 3/16 inch thick. The thicker faceplates may be deployed where tampering is a particular danger. Faceplate 310 has two faceplate mounting holes 352 and lens hole 354. The underside of faceplate 310 coated with a flat black paint except for lens hole 354. Lens hole 354 acts as a window for the line of sight of the camera. Faceplate mounting holes are used to secure the faceplate to the camera frame top and to hold in place dampers 402. Lens hole 354 is not a hole through the material; rather lens hole 354 is a small circular transparent area that allows camera 306 to capture images through faceplate 310. In the preferred embodiment, the diameter of lens hole 354 is approximately ¼ inch. In other embodiments, faceplate 310 can be designed to resemble an EXIT sign, CAUTION sign, or other insignia such as a ruler or a mirrored surface.

As shown in FIG. 2, light emitting diodes 311 can be embedded in faceplate 310 and programmed to scroll signs or banners across its surface as is known in the art. The LEDs can also emit infrared light to enable the camera to function in dark conditions. Faceplate 310 is attached to camera frame top 302 and dampers 402 with two flathead faceplate screws 351. Faceplate mounting holes 352 are countersink holes to allow faceplate screws 351 to sit flush with faceplate 310.

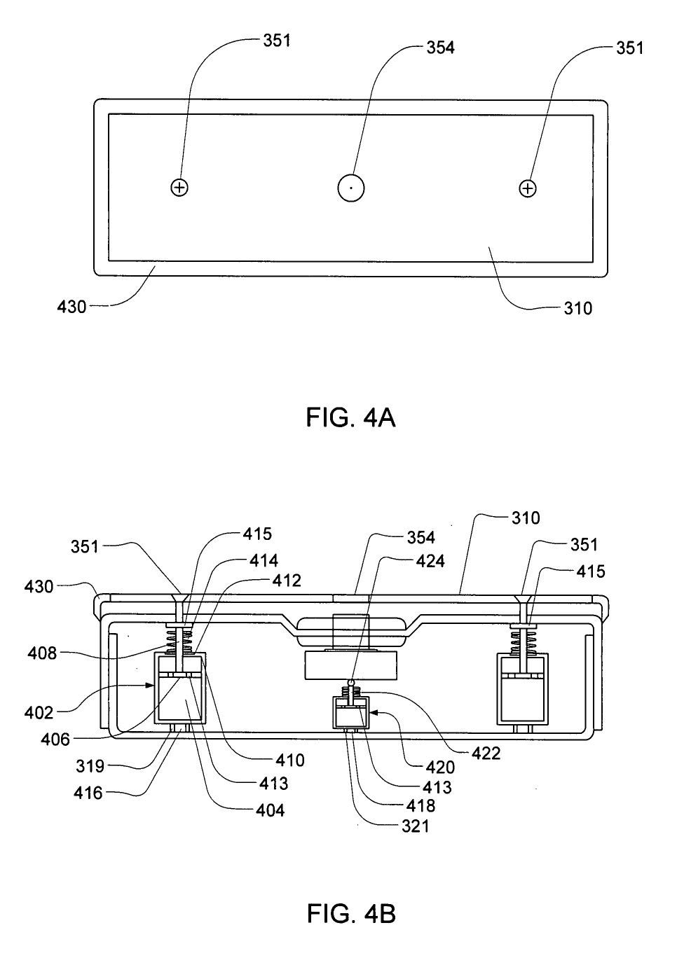

FIG. 4 shows shock absorbing fluid dampers 402 mounted inside camera frame assembly 210. The dampers are provided to absorb impact shock to the faceplate. Damper 402 includes chamber 404 in which resides movable piston 406. Piston 406 is attached to piston rod 408. Piston rod 408 projects through end-wall 410. Chamber 404 is filled with a viscous damper fluid such as mineral oil or glycerin. Holes 413 within the piston head allow for the damper fluid to move from one end of the cylinder to the other as the piston head moves. Seal 412 is provided in end-wall 410 surrounding piston rod 408. Stop rings 415 are rigid disks attached at a predetermined position on the piston rod. The stop rings prevent removal of the faceplate by prying. Spring 414 is positioned around piston rod 408 in between the top surface of chamber 404 and inside surface of camera frame top 302 to bias the piston in an extended position. Spring 414 can also be housed inside chamber 404 beneath piston 406 in order to bias the piston in the extended position.

Dampers 402 are secured to the bottom surface of camera frame top 302 by faceplate screws 351. Dampers 402 are held in position by damper base bolts 416 in the damper holder 319 located on camera frame bottom 304.

Damper 420 is positioned under camera 306. Damper 420 is held in place by damper base bolt 418 in damper holder 321 located under camera 306. Piston rod 422 contacts the bottom surface of camera 306 via piston ball 424 located on the end of piston rod 422. Piston ball 424 is a non-metallic substance in the preferred embodiment to prevent electrical connection of the piston with the camera body. The piston ball is positioned to deflect downwardly and slide along the bottom of the camera. The piston ball is also configured to also allow the camera bottom to pivot without losing contact with it.

The piston can be displaced by impact to the faceplate. After displacement, spring 414 returns to the extended piston 406 position in the minimum time possible without oscillation. The spring and damper combination in the preferred embodiment is chosen to have spring and damper coefficients that provide for critical damped behavior. Overdamped behavior is also preferable in situations where repeated impacts are less likely.

FIG. 4 also shows faceplate skirt 430. Faceplate skirt 430 is made of rubber or flexible plastic and is attached along the circumference of faceplate 310. The faceplate skirt is designed to slide along the outside of the camera housing in order to allow for movement of the faceplate with respect to the housing. Faceplate skirt 430 is used to form a barrier to dust, debris and moisture. Faceplate skirt 430 can also be adapted to serve as a weather seal for outdoor use.

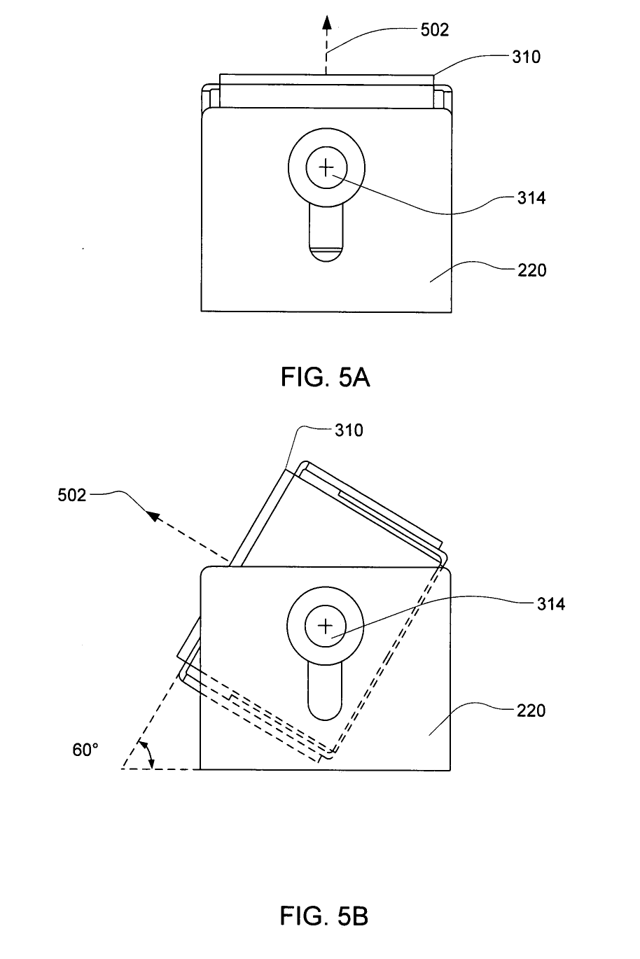

FIGS. 5a and 5b show an elevation view of the camera apparatus. FIG. 5a depicts the orientation of camera frame assembly 210. In this configuration, 0° from center, camera sight line 502 is perpendicular to faceplate 310 and to mounting bracket 220. FIG. 5b depicts the orientation of camera frame assembly 210 rotated along the central axis of bolts 314 60° from center. The present invention is capable of adjusting the orientation of camera frame assembly through any angle between zero degrees and sixty degrees either direction for a range of motion of about 120 degrees.

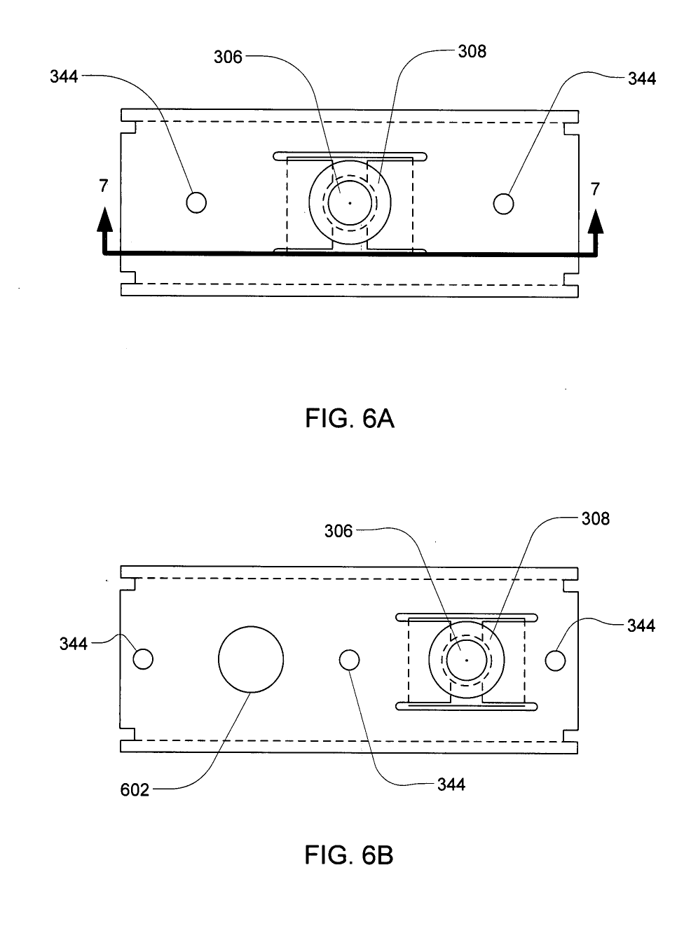

FIG. 6a shows a top view of camera frame top 302 with grommet 308 and camera 306 in place. FIG. 6b shows a top view of another embodiment of camera frame top 302 including device pass-through hole 602 and additional faceplate holes 344. Device pass-through hole 602 is located behind where the additional device (not shown) would be mounted and is sized appropriately to allow the pass-through of the necessary cables and power cords connected to the device. Accordingly, the locations of camera hole 342, mounting flanges 340, and faceplate holes 344 are adjusted as shown to accommodate the additional device.

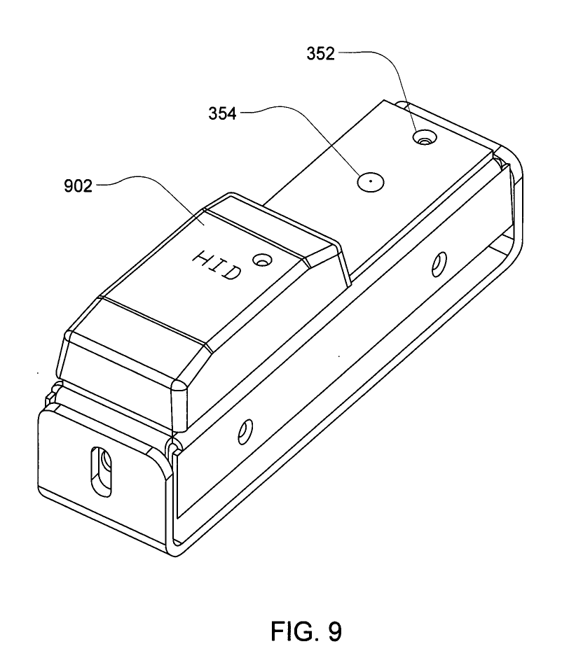

FIG. 9 shows the assembled apparatus including the attachment of card reader 902. Accordingly, the locations of lens hole 354 and faceplate mounting holes 352 are adjusted as shown to accommodate the addition of card reader 902. In the preferred embodiment, if faceplate 310 is enabled to send active messages, such as with a series of light emitting diodes, messages can be displayed. For example, a clock display, an “Entry Allowed” message, an “Entry Denied” message or other messages can be displayed or scrolled across the faceplate with the aid of a digital computer as is known in the art.

In additional embodiments, different security devices can be attached to the apparatus. Different devices such as thumbprint readers, iris scanners, voice recognition sensors or motion detectors can be implemented.

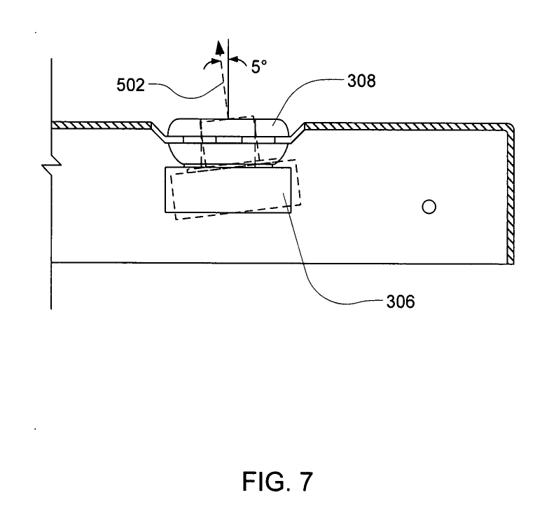

FIG. 7 is a section view taken along line 7-7 of FIG. 6a depicting camera sight line 502 adjusted approximately five degrees. The friction fit between the camera and the grommet allows camera 306 to be slightly adjusted in any direction while seated in grommet 308.

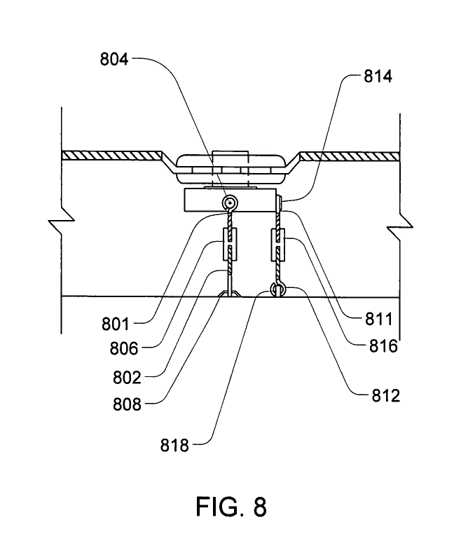

FIG. 8 is a section view taken along 7-7 of FIG. 6a depicting an alternate embodiment. A set of two adjustable turnbuckles are provided which rigidly fix the angle of the camera in the grommet but provide for rotation about two axes of the camera. The turnbuckles can be used with or without the spring damper mechanisms. The turnbuckles include a set of pivot point screws 804 and 814; a pair of oppositely threaded eyelet bolts 801 and 802, and 811 and 812; two turnbuckle bodies 806 and 816 and tabs 808 and 818. Pivot point screw 804 attaches threaded eyelet bolt 801 to one side of camera 306. Pivot point screw 814 attaches threaded eyelet bolt 811 to an adjacent side of camera 306. The threaded end of eyelet bolts 801 and 811 are inserted into turnbuckle bodies 806 and 816 respectively. Eyelet bolts 802 and 812 are also inserted into the turnbuckle bodies 806 and 816 and are further attached to camera frame bottom 304 through tabs 808 and 818 respectively.

Varying the overall length of each turnbuckle tilts camera 306 in various directions. The cooperation of the turnbuckles provides a means of adjustment of the camera in two orthogonal planes up to approximately five degrees in any direction in the preferred embodiment. The eyelet bolts and turnbuckle bodies can be made of plastic to prevent electrical contact between the camera and the enclosure. In an alternate embodiment, the eyelet bolts and tabs may be coated with a rubber covering to insulate them from the enclosure. In an alternate embodiment, tabs 808 and 818 may be on an internal surface of the camera frame.

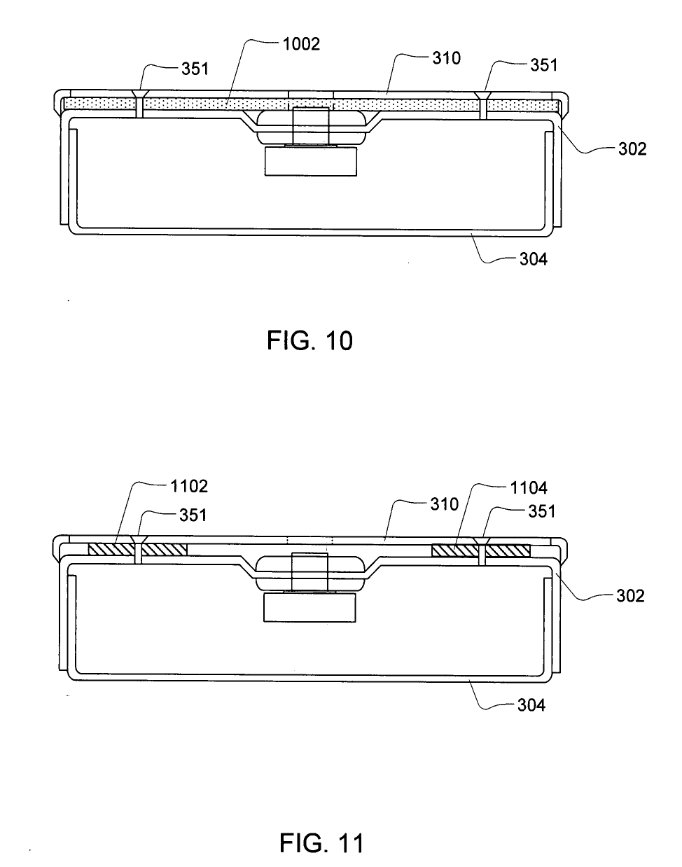

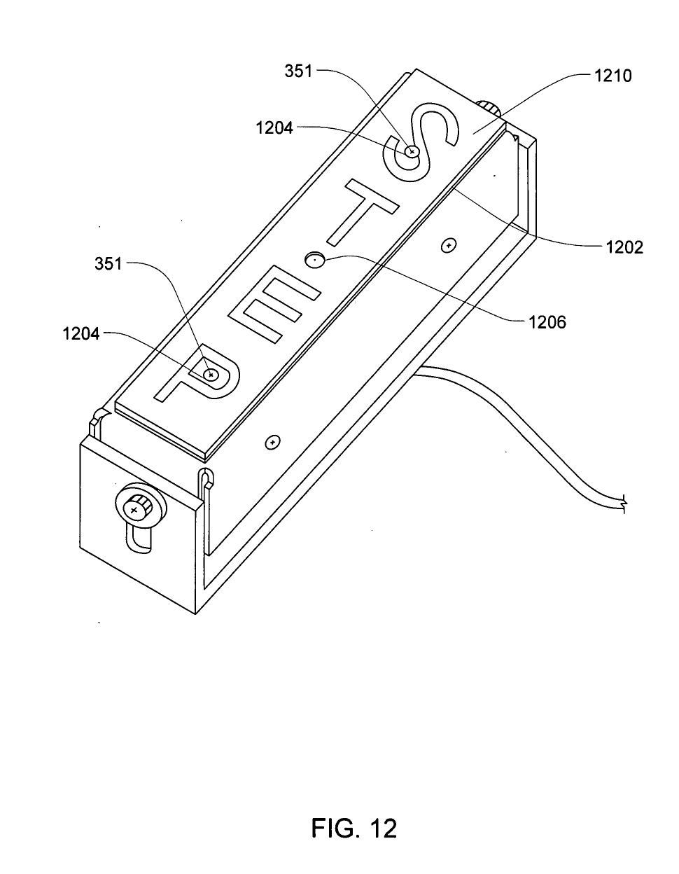

In other embodiments of the present invention such as shown in FIG. 10, a layer of closed cell plastic shock absorbing foam 1002 is secured between faceplate 310 and the top surface of camera frame top 302. In still other embodiments as shown in FIG. 11, shock absorbing rubber washers 1102 and 1104 are secured by faceplate screws 351 and located between faceplate 310 and the top surface of camera frame top 302. The foam and washers may be used in any embodiment of the invention to add additional impact resistance and weather resistance.

Another embodiment of the present invention is shown in FIG. 12. FIG. 12 shows the assembled apparatus including transparent faceplate 1210 and an interchangeable insert 1202 mounted under transparent faceplate 1210. In this embodiment, transparent faceplate 1210 is completely transparent. The transparency of faceplate 1210 permits insert 1202 to be visible through faceplate 1210. Insert 1202 is constructed of a thin layer of flexible plastic such as polystyrene or PVC but can also be constructed of laminated paper or cardboard. In a preferred embodiment, insert 1202 has the same length and width dimensions as transparent faceplate 1210, and a thickness that is approximately half that of transparent faceplate 1210. Insert 1202 includes lens hole 1206. Lens hole 1206 is an approximately ¼ inch diameter hole and allows a camera mounted in the camera frame assembly underneath to capture images through transparent faceplate 1210. In this example, insert 1202 is shown with the word “STEP” inscribed on it to accommodate mounting of the device next to a set of stairs on a school bus. Of course, any message or design may be printed on the insert. Multiple inserts can be provided with any desired words, phrases or images printed thereon and easily swapped out as the need arises. If transparent faceplate 1210 is enabled to send active messages, such as with a series of light emitting diodes, the signage on insert 1202 may be positioned such that the LEDs work in conjunction with the printed words or symbols to display various messages.

Insert 1202 may also be provided with a heat sensitive paint. The heat sensitive paint can be used to indicate a fire condition on one side or the other of a doorframe or be arranged to indicate the temperature of the unit in Arabic numbers. Examples of heat sensitive paint are shown in Pressure and Temperature Sensitive Paints by Tianshu Liu and John P. Sullivan (Springer 2004), incorporated herein by reference. In yet another embodiment, insert 1202 may be imprinted with a pressure sensitive paint which reflects evidence of tampering by changing color with the pressure between the insert and the frame is varied. Examples of pressure sensitive paints are shown in Dual Luminophore Pressure-Sensitive Paint—I. Ratio of Reference to Sensor Giving a Small Temperature Dependency, by G. E. Khalil, C. Costin, J. Crafton, G. Jones, S. Grenoble, M. Gouterman, J. B. Callis and L. R. Dalton in Sensors and Actuators B: Chemical, Volume 97, Number 1, 1 Jan. 2004, pp. 13-21(9), incorporated herein by reference.

In another embodiment, to facilitate the interchangeability of insert 1202, removable adhesive laminates may be affixed to a reusable insert. In another embodiment, insert 1202 replaces the closed cell plastic shock absorbing foam shown in FIG. 10 or the shock absorbing rubber washers shown in FIG. 11. In yet another embodiment, the closed cell plastic shock absorbing foam can be imprinted with the message.

FIG. 14 shows another alternate embodiment of the invention. In this embodiment, a camera, unit 1504, is fitted with a faceplate 1503 which includes a lenticular lens 1502. Behind the lenticular lens is a printed interchangeable insert 1505 designed to work in cooperation with lenticular lens 1502. A lenticular lens, as known in the prior art, is a type of Fresnel lens which can be arranged to provide the illusion of different pictures when viewed from different viewing angles. An example of a lenticular lens and image providing this capability can be found in U.S. Pat. No. 5,924,870 to Gottfried. The disclosure of U.S. Pat. No. 5,924,870 is incorporated herein by reference.

In the current embodiment of the invention, insert 1505 is printed with a pattern to reflect three messages from different viewing angles in front of camera 1504. Directly within the camera field of view, denoted in FIG. 14 as area 1506, the insert is printed to reflect the message “CORRECT POSITION”. The view of the camera face from area 1506 is shown as faceplate appearance 1514. In the viewing area 1510 to the left of camera 1504, insert 1505 is printed so that when viewed through lenticular lens 1502, it projects the message “MOVE RIGHT”. The appearance of the camera in area 1510 is shown as faceplate appearance 1516. In the area designated 1508 to the right of camera 1504, the insert 1505 in conjunction with lenticular lens 1502 shows the message “MOVE LEFT”. The appearance of the “MOVE LEFT” message on the face of the camera is shown in the figure as faceplate appearance 1512.

This particular embodiment is useful in applications of the security camera in security portals and other secured areas where the subject of the camera is aware of the camera. One skilled in the art will recognize that the advantage of this embodiment is that the subject is instructed to move into the correct camera field of view without the necessity for verbal instructions by an operator or feedback from a video display. One skilled in the art will further recognize that any set of messages or displays may be included on insert 1505 which provide for changing messages through lenticular lens 1502 in other embodiments.

Returning to FIG. 12, transparent faceplate 1210 is mounted to the camera frame assembly with faceplate screws 351 through faceplate mounting holes 1204. Faceplate screws 351 also pass through insert 1202 to secure insert 1202 between the camera frame assembly and transparent faceplate 1210. The location of faceplate mounting holes 1204 and lens hole 1206 may vary with the intended use of the apparatus and can be further adjusted to accommodate different security devices attached to the apparatus.

In practice, to change the interchangeable insert from one to another, faceplate screws 351 are removed and transparent faceplate 1210 and insert 1202 are detached from the camera frame assembly. A different insert is then repositioned on the camera frame assembly and covered by transparent faceplate 1210. Faceplate screws 351 are inserted through faceplate mounting holes 1204 and the concentrically aligned insert mounting holes and tightened.

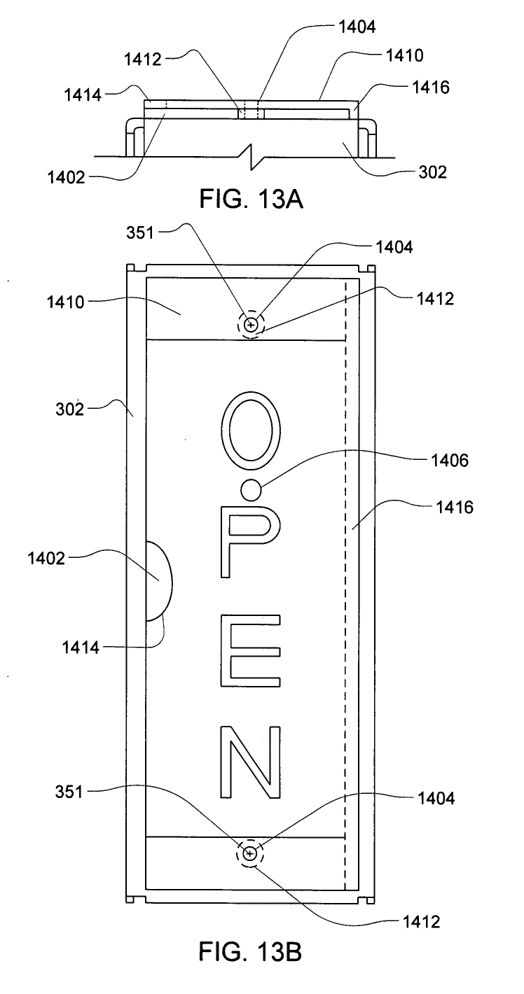

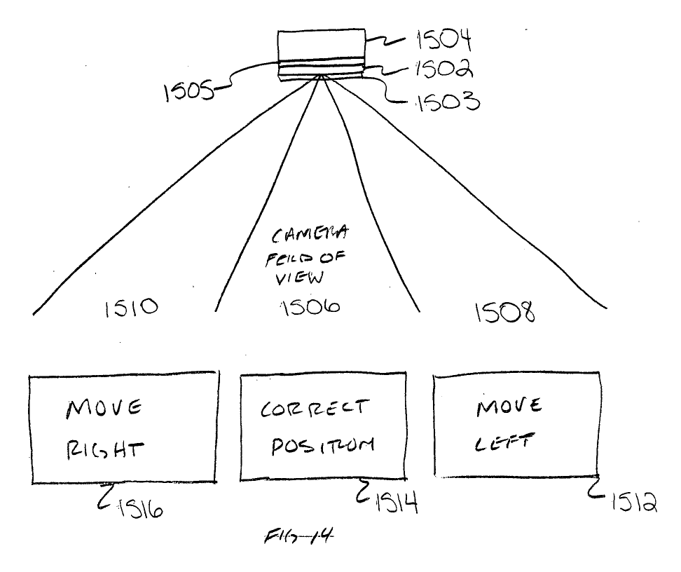

Another embodiment of the present invention is shown in FIGS. 13a and 13b. Faceplate 1410 is transparent and includes guide 1416 and stanchions 1412. Faceplate 1410 is mounted to camera frame top 302 with a pair of faceplate screws 351 through faceplate mounting holes 1404. Guide 1416 is an abutment and standoff that runs the length of faceplate 1410 along one edge of faceplate 1410 and is adjacent to the top surface of camera frame top 302. Guide 1416 is generally the same thickness as faceplate 1410 and extends perpendicularly from faceplate 1410 for a depth equal to the thickness of insert 1402. Stanchions 1412 have a depth equal to the thickness of insert 1402. In conjunction with guide 1416, stanchions 1412 maintain a gap between faceplate 1410 and the top surface of camera frame top 302. Insert 1402 is housed in the gap created by guide 1416 and stanchions 1412. Faceplate 1410 also includes access indention 1414. Access indention 1414 is generally a semicircular shaped cutout. Access indention 1414 exposes insert 1402 below faceplate 1410 so that insert 1402 may be easily grasped and removed from underneath faceplate 1410 without unmounting faceplate 1410. Insert 1402 is sized to fit underneath faceplate 1410 and in between stanchions 1412 and guide 1416. Therefore, the overall length of insert 1402 is less than the length of faceplate 1410 and the overall width of insert 1402 is less than the width of faceplate 1410.

Insert 1402 can be easily removed from the unit by grasping the portion exposed by access indention 1414 of faceplate 1410. The length of insert 1402 is approximately the same as the distance between stanchions 1412 and in the preferred embodiment, is approximately five inches. Insert 1402 is frictionally held in place between the top surface of camera frame top 302 and the underside of faceplate 1410. Additionally, stanchions 1412 and guide 1416 help properly align insert 1402 so that lens hole 1406 is concentrically aligned over the camera mounted in camera frame top 302. Guide 1416 prevents the insert from sliding out the other side of faceplate 1410. Stanchions 1412 and guide 1416 ensure lens hole 1406 is properly aligned over the camera mounted in camera frame top 302.

The preferred embodiment shown in FIG. 14 may be used where the signage displayed is changed frequently. In situations such as a bank teller where the frequent message change is often limited to two different messages (“open” and “closed”), the two messages may be imprinted on opposite sides of the same insert.

The preferred method of use of the present invention requires the steps of first attaching mounting bracket 220 in a desired location on a mounting surface. The mounting surface should provide an advantageous camera sight line and still be discreet. The easily adjustable nature of covert camera apparatus 200 allows the option of numerous locations because the sight line of camera 306 can be easily corrected. After connecting the power cords and video cables to a power source and video recording or video display device, the next step is securing camera frame assembly 210 mounting bracket 220. Verifying the camera sight line on the video display source ensures the apparatus is capturing the desired field of view. Adjusting the camera angle by loosening but not removing the bolts securing camera frame assembly 210 to mounting bracket 220 and rotating camera frame assembly to the desired angle is the final step. Adjusting the camera angle by the internal adjusting means fine tunes the camera sight line.

It will be appreciated by those skilled in the art that changes could be made to the embodiments described above without departing from the broad inventive concept thereof. It will also be appreciated by those of skill in the art that many of the discussed embodiments may be used in combination with one another. It is understood, therefore, that this invention is not limited to the particular embodiments disclosed, but it is intended to cover modifications within the spirit and scope of the present invention as defined by the appended claims.

1. An apparatus for video surveillance comprising:
a mounting bracket;
a camera enclosure having a circular opening and an internal surface and an external surface supported by the mounting bracket;
an opposing set of camera supports, forming a semicircular opening, rigidly fixed to the internal surface of the camera enclosure;
a rubber camera grommet having a grommet hole mounted in the semicircular opening;
a video camera having a lens extension mounted adjacent the lens opening;
the lens extension frictionally mounted in the grommet hole;
a faceplate mounted to the external surface by at least one shock absorbing faceplate standoff; and
an imprinted insert adjacent to and visible through the faceplate.

2. The apparatus of claim 1 where the mounting bracket is comprised of a mounting bracket base and two mounting bracket sides each having an oblong opening of constant width and each mounting bracket side rigidly connected to the mounting bracket base.

3. The apparatus of claim 1 where the grommet is comprised of an electrical insulator and flexibly secures the lens extension to the set of camera supports.

4. The apparatus of claim 1 where the shock absorbing standoff is a spring damper mechanism.

5. The apparatus of claim 4 further comprising a second spring damper mechanism supporting the video camera by a ball connector which electrically insulates the video camera from the camera enclosure.

6. The apparatus of claim 1 where the shock absorbing standoff is a sheet of closed cell plastic foam extending the length of the faceplate.

7. The apparatus of claim 1 where the shock absorbing standoff is a rubber washer.

8. The apparatus of claim 1 where the faceplate includes a window adjacent to the lens opening.

9. The apparatus of claim 1 where the faceplate includes light emitting diodes programmed to display messages.

10. The apparatus of claim 1 further comprising a set of interchangeable imprinted inserts; each bearing a different written message.

11. The apparatus of claim 1 where the camera enclosure is pivotally mounted to the mounting bracket.

12. The apparatus of claim 1 where the adjusting means comprises two adjusting assemblies orthogonally related to each other each comprising a first threaded eyelet connected to a threaded collar, a second threaded eyelet connected to the opposing end of the collar, and a loop securing the other end of the second eyelet.

13. The apparatus of claim 1 where the imprinted insert is painted with a pressure sensitive paint.

14. The apparatus of claim 1 where the imprinted insert is painted with a temperature sensitive paint.

15. The apparatus of claim 1 wherein the faceplate includes a lenticular lens and wherein the imprinted insert includes an image which cooperates with the lenticular lens to display a set of images through the faceplate.

16. The apparatus of claim 15 wherein the set of images is indexed to a set of viewing zones related to a field of view of the video camera.

17. An apparatus for covert video surveillance of an environment comprising:
a mounting bracket;
a camera frame assembly having a camera frame top and a camera frame bottom pivotally mounted to the mounting bracket;
the camera frame top having a pair of offset flanges surrounding a camera opening;
a grommet having a recess mounted on the offset flanges;
a camera having a camera bottom, a camera body and a lens;
the lens frictionally mounted in the grommet;
a camera angle adjustment means connected to the camera body, for variable adjusting of a camera angle;
at least one shock absorbing damper attached to the camera frame bottom;
the camera frame top secured to the camera frame bottom;
a faceplate secured to the at least one shock absorbing damper;
an insert means, adjacent to and visible through the faceplate for communicating a message; and
the insert means bearing an active imprint means thereon, for changing the message according to a condition of the environment.

18. The apparatus of claim 17 where the mounting bracket is comprised of a mounting bracket base and two mounting bracket sides each having an oblong opening of constant width and each mounting bracket side rigidly connected to the mounting bracket base.

19. The apparatus of claim 17 where the condition of the environment is heat.

20. The apparatus of claim 17 where the condition of the environment is pressure.

21. The apparatus of claim 17 where the faceplate includes a window adjacent to the camera.

22. The apparatus of claim 17 where the faceplate includes light emitting diodes.

23. The apparatus of claim 17 wherein the insert means includes a plurality of inserts bearing different messages.

24. The apparatus of claim 17 where the adjusting means comprises two adjusting assemblies orthogonally related to each other each comprising a first threaded eyelet connected to a threaded collar, a second threaded eyelet connected to the opposing end of the collar, and a loop securing the other end of the second eyelet.

25. The apparatus of claim 17 where a card reader is attached to the faceplate.

26. The apparatus of claim 17 further comprising a camera shock absorbing damper in pivotal and slideable contact with the camera bottom.

27. The apparatus of claim 17 wherein the at least one shock absorbing means further comprises:
a fluid filled damper cylinder containing a damper piston and a damper spring;
wherein the damper piston includes a piston rod extending out of the damper cylinder and connected to the faceplate; and,
wherein the piston rod includes a stop ring means, adjacent the camera frame top, to prevent removal of the faceplate.

28. A method of mounting a video surveillance system comprising:
providing a mounting bracket with a mounting bracket base, two mounting bracket sides, and two adjustable bolts;
providing a camera frame assembly of a camera frame top connected to a camera frame bottom;
providing a camera mounted to the camera frame assembly through a rubber grommet;
providing an orthogonal set of threaded adjustment means, connected to the camera and the camera frame assembly;
providing a transparent faceplate covering the camera and attached to the camera frame assembly;
providing a set of imprinted inserts, each adapted to fit between the faceplate and the camera frame top;
attaching the mounting bracket to a structure;
attaching the camera frame assembly to the mounting bracket with the two bolts;
orienting the camera frame assembly in the mounting bracket to the desired camera angle;
orienting the camera in the rubber grommet by the threaded adjustment means; and
placing one of the set of imprinted inserts between the faceplate and the camera frame top.

29. The method of claim 28 further comprising:
providing a lighted indicator means on the faceplate;
providing a scanner on the camera frame; and,
activating the lighted indicator means upon receipt of a signal from the scanner.

30. The method of claim 28 further comprising:
providing at least one of the set of imprinted inserts that is imprinted with a paint capable of reacting to a change in the pressure between the faceplate and the camera frame top.

31. The method of claim 28 further comprising:
removing and reattaching the faceplate to change the insert.

32. The method of claim 28 further comprising:
sliding the insert out and reinserting a second insert of the set of imprinted inserts between the faceplate and the camera frame top to change the insert.

33. An apparatus for covert video surveillance comprising:
a mounting bracket having a mounting bracket base and two mounting bracket sides each having an oblong opening of constant width and each mounting bracket side rigidly connected to the mounting bracket base;
a camera frame assembly having a circular opening and an internal surface and an external surface pivotally mounted to the mounting bracket;
an opposing set of camera supports, forming a semicircular opening, rigidly fixed to the internal surface of the camera frame assembly;
a rubber grommet having a grommet hole, a recess surrounding the vertical midpoint of the grommet, and mounted in the semicircular opening;
a video camera having a lens extension mounted adjacent to a lens opening;
the lens extension frictionally mounted in the grommet hole;
a transparent faceplate mounted to the external surface; and,
an imprinted insert having a circular opening mounted between the faceplate and the external surface.

34. The apparatus of claim 33 where the grommet is comprised of an electrical insulator and flexibly secures the lens to the set of camera supports.

35. The apparatus of claim 33 where the faceplate includes light emitting diodes programmed to display messages.

36. The apparatus of claim 33 where the faceplate includes a means for allowing removal of the imprinted insert without removal of the faceplate.

37. The apparatus of claim 36 where the imprinted insert is removably mounted between the faceplate and the external surface.

38. The apparatus of claim 33 where the insert is interchangeable.

39. The apparatus of claim 33 where the insert cooperates with a lenticular lens means for changing an appearance of the faceplate dependent on a viewing angle.

40. The apparatus of claim 33 where the insert is imprinted with temperature sensitive paint.

41. The apparatus of claim 33 where the insert is imprinted with pressure sensitive paint.

42. The apparatus of claim 33 wherein the imprinted insert includes a means for detection of tampering resulting in a visual change in the imprinted insert.
